(19) United States
(12) Patent Application Publication
(10) Pub. No.: US 2007/0271271 A1
(43) Pub. Date: Nov. 22, 2007

(54) METHOD, SYSTEM, AND PROGRAM PRODUCT FOR CONDUCTING A CROSS-ORGANIZATIONAL TRANSACTION AUDIT

(76) Inventors: Nanchariah R. Chalasani, Fairfax, VA (US); Jiayue Chen, Atlanta, GA (US); Jacob D. Eisinger, Blacksburg, VA (US); Josephine R. Gordon, Austin, TX (US); David G. Keuhr-McLaren, Apex, NC (US); Eric J. McNeil, Chapel Hill, NC (US); Luke T. Rajlich, Champaign, IL (US)

Correspondence Address: HOFFMAN WARNICK & DALESSANDRO LLC, 75 STATE ST, 14TH FLOOR, ALBANY, NY, 12207, US

(21) Appl. No.: 11/419,060

(22) Filed: May 18, 2006

(51) Int. Cl. G06F 17/30

(52) U.S. Cl. 707/8

(57) ABSTRACT

The invention provides a method, system, and program product for conducting a cross-organizational transaction audit. In one embodiment, the invention includes a first entity requesting that a second entity perform a task; a third entity creating a log of information related to the second entity's performance of the task and verifying to the first entity that the task was performed; the first entity examining the log to determine at least one of the following: whether the second entity's performance of the task was satisfactory and how the second entity used information provided by the first entity in performing the task; and the first entity verifying that the second entity's performance of the task was satisfactory.

### BACKGROUND OF THE INVENTION

1. Technical Field

The invention relates generally to cross-organizational audits and more particularly, to a method, system, and program product for conducting a cross-organizational transaction audit.

2. Background Art

Identity theft is among the fastest growing crimes in the U.S. In 2004, identity theft in the U.S. affected approximately 9.3 million individuals and totaled over $56.6 billion. A large portion of identity thefts occur as a consequence of insecure communications between customers and businesses and between two or more businesses.

In addition, businesses are facing increased regulations regarding the protection of consumer information. Notable examples of such regulation include the Health Insurance Portability and Accountability Act of 1996 (HIPPA) and the Gramm-Leach-Bliley Act of 1999 (GLBA). While a business may have great control over the security of consumer information within its own systems and operations, it may have little or no control over the security of such information once it is shared with another business with which it must interact.

While the risks above suggest that a business should not share consumer information with other businesses or agencies, the realities of the current business landscape make such an approach impractical or impossible. Collaboration with other businesses is often essential to maintaining a competitive advantage, improving efficiencies, or providing the products or services consumers have come to expect.

To this extent, a need exists for a method for ensuring secure transactions between two or more entities, such as businesses involved in the exchange of sensitive consumer information.

### SUMMARY OF THE INVENTION

The invention provides a method, system, and program product for conducting a cross-organizational transaction audit. In one embodiment, as data is transferred between entities for processing, valid audit logs are created at each entity though which the data passes. Such audit logs may include information regarding the usage of the data in performance of a particular task. Thus, the owner/originator of the data used in a transaction may request and/or review audit logs related to the data and/or its usage regardless of the number of entities that the data passes through during a transaction. The invention includes a first entity requesting that a second entity perform a task; a third entity creating a log of information related to the second entity's performance of the task and verifying to the first entity that the task was performed; the first entity examining the log to determine at least one of the following: whether the second entity's performance of the task was satisfactory and how the second entity used information provided by the first entity in performing the task; and the first entity verifying that the second entity's performance of the task was satisfactory.

A first aspect of the invention provides a method for auditing a transaction between a plurality of entities, the method comprising: a first entity requesting that a second entity perform a task; creating a log of information related to the second entity's performance of the task; verifying to the first entity that the task was performed; and examining the log to determine at least one of the following: whether the second entity's performance of the task was satisfactory and how the second entity used information provided by the first entity in performing the task.

A second aspect of the invention provides a system for auditing a transaction between a plurality of entities, the system comprising: a system for permitting a first entity to request that a second entity perform a task; a system for creating a log of information related to the second entity's performance of the task; a system for verifying to the first entity that the task was performed; and a system for examining the log to determine at least one of the following: whether the second entity's performance of the task was satisfactory and how the second entity used information provided by the first entity in performing the task.

A third aspect of the invention provides a program product stored on a computer-readable medium, which, when executed conducts an audit of a transaction between a plurality of entities, the program product comprising: program code for permitting a first entity to request that a second entity perform a task; program code for creating a log of information related to the second entity's performance of the task; program code for verifying to the first entity that the task was performed; and program code for examining the log to determine at least one of the following: whether the second entity's performance of the task was satisfactory and how the second entity used information provided by the first entity in performing the task.

A fourth aspect of the invention provides a method for deploying an application for auditing a transaction between a plurality of entities, comprising: providing a computer infrastructure being operable to: permit a first entity to request that a second entity perform a task; create a log of information related to the second entity's performance of the task; verify to the first entity that the task was performed; and examine the log to determine at least one of the following: whether the second entity's performance of the task was satisfactory and how the second entity used information provided by the first entity in performing the task.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-3 show block diagrams of illustrative embodiments of the invention.

FIG. 4 shows a flow diagram of an illustrative method according to the invention.

FIG. 5 shows a flow diagram of an alternative method according to the invention.

FIG. 6 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a method, system, and program product for conducting a cross-organizational transaction audit.

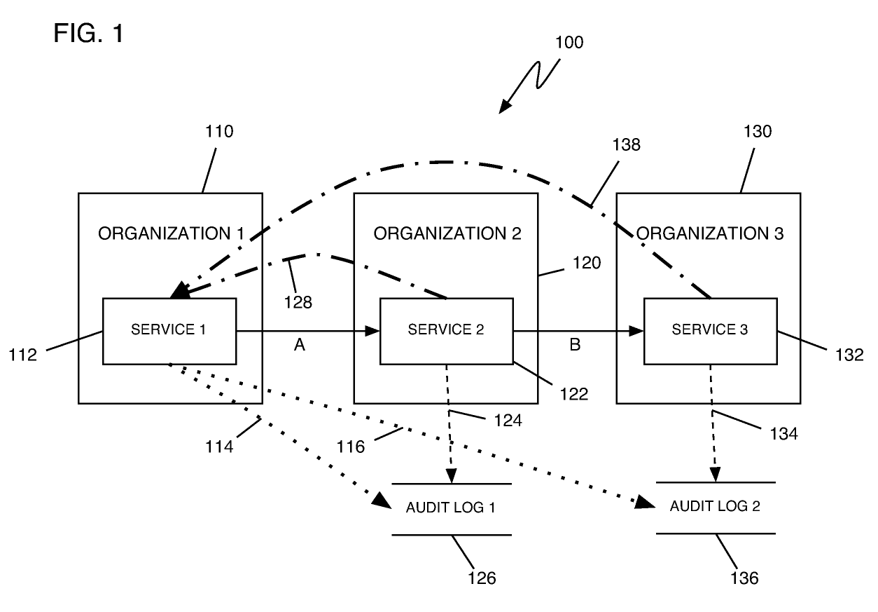

FIGS. 1-3 show various illustrative embodiments of the invention. In FIG. 1, a transaction 100 among three organizations 110, 120, 130 is shown, each capable of providing a particular service 112, 122, 132. The normal workflow between organizations 110, 120, 130 follows the paths of requests A and B, whereby organization 1 110 requests that organization 2 120 provide service 2 122 and organization 2 120 requests that organization 3 130 provide service 3 132. Any number of other workflows are possible, that of FIG. 1 being provided merely for purposes of illustration and simplicity. In addition, as used above, a first organization's provision of a service to a second organization includes the first organization's performance of a task.

In order to ensure that the services requested of each organization are performed in a satisfactory manner, each organization requested to provide a service (i.e., perform a task) produces 124, 134 an audit log 126, 136 containing information related to its performance of one or more tasks associated with its provision of the service. Such information may include, for example, a date and/or time that the task was initiated and/or completed, data generated as a consequence of the organization's performance of the task, and data used by the organization in performance of the task. In a preferred embodiment, the organization requesting a service provides to the organization providing the service a unique identifier associated with the service request. This unique identifier is preferably included in the audit log 126, 136 generated by the organization providing the service.

As can be seen in FIG. 1, organization 2 120 may, upon receiving a request A from organization 1 110, make its own request B that organization 3 130 provide a service. Such a subordinate service request may be made, for example, if organization 2 120 is incapable of providing all services requested by organization 1 110. In such a case, organization 3 130 produces 134 its own audit log 136 containing information related to its performance of one or more tasks associated with its provision of the service requested in request B. The requesting organization (organization 1 110 in FIG. 1) may then examine 114, 116 the audit logs 126, 136 of each organization providing a service in order to ensure that the services were provided in a satisfactory manner.

In addition to the preparation of audit logs, organizations providing requested services may also verify 128, 138 to a requesting organization that it has provided the requested service (i.e., performed one or more tasks associated with the provision of a service). Such verification may include, for example, data contained in audit logs 126, 136 or may simply comprise a communication to the requesting organization that one or more tasks associated with the requested service has been performed. In the latter case, verification 128, 138 may provide the impetus for the requesting organization (e.g., 110) to examine (e.g., 114, 116) the audit logs (e.g., 126, 136) prepared by the organizations providing the service (e.g., 120, 130).

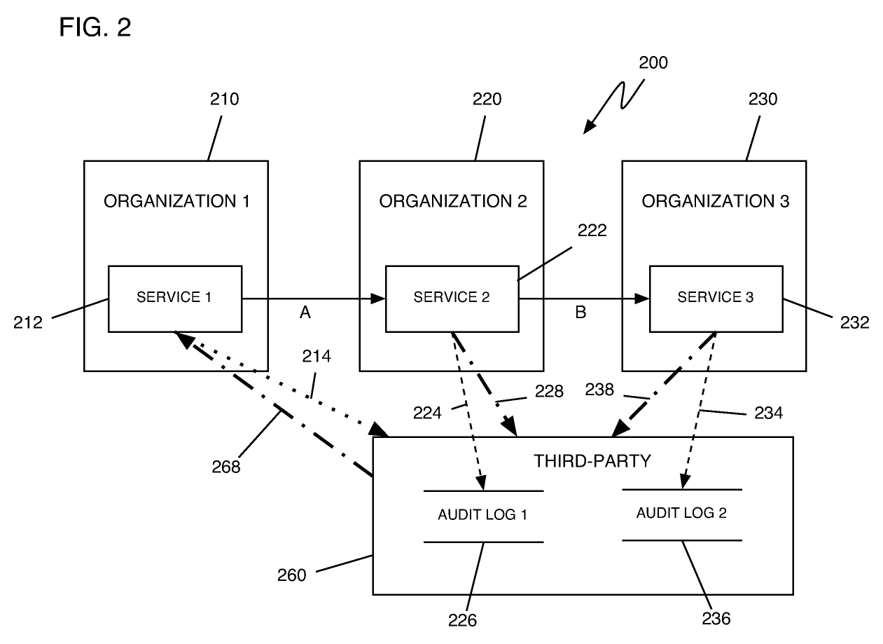

In reality, cross-organizational transactions are likely to be much more complicated than that shown in FIG. 1. Such transactions may include dozens of requests for services and as many or more organizations providing those services. Communications between organizations can therefore become voluminous, requiring a great deal of time and effort to coordinate. One solution to such difficulties is shown in the transaction 200 of FIG. 2, wherein a third-party organization 260 acts as an intermediary between the requesting organization and service-providing organizations. In a preferred embodiment, third-party organization 260 does not, itself, provide services to any other organization in transaction 200. Rather, third-party organization 260 serves as a repository for data associated with the provision of requested services and a centralized communication point between other organizations involved in transaction 200.

For example, third-party organization 260 houses audit logs 226, 236. Such audit logs may either be generated by the third-party organization 260 itself or transmitted to third-party organization 260 from service-providing organizations 220, 230. As can be seen in FIG. 2, service-providing organizations 220, 230 may still provide verifications 228, 238 that they have performed one or more tasks associated with the requested service. However, such verifications are made to third-party organization 260 rather than to the requesting organization, as in FIG. 1. As a result, communications between organizations in transaction 200 are greatly simplified, particularly with respect to requesting organization 210. No matter how many service-providing organizations are involved, requesting organization 210 may receive as few as one verification 268 from third-party organization 260 and may make as few as one examination 214 of audit logs 226, 236.

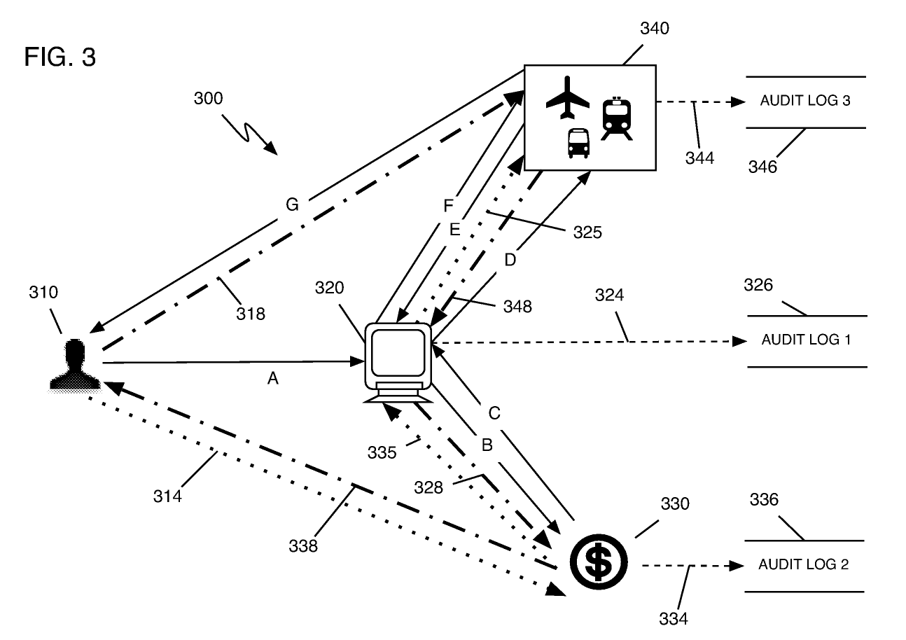

As described above, the present invention may be employed to audit any cross-organizational transaction involving any number and type of organizations providing any number and type of services. However, in order to better describe the interactions between organizations and the auditing capabilities afforded by the present invention, FIG. 3 shows a transaction 300 involving a customer 310 placing an order A with an online retailer 320. Steps A through G represent a typical workflow of such a transaction. Upon receiving an order A, online retailer 320 may contact B financial institution 330 to request payment, using information provided by customer 310 (e.g., credit card number, expiration date, authorized amount, etc.). Financial institution 330 may then make payment C to online retailer 320, at which time online retailer 320 requests shipment D of products associated with order A by shipping company 340. Shipping company may then request E and receive F payment for such shipment and then ship G the ordered products to customer 310.

Each of steps A through G may generate data associated with the request and/or performance of an associated task. As in FIGS. 1-2, each organization providing a service (i.e., performing a task) may generate an audit log 326, 336, 346 containing data associated with its provision of services. For example, audit log 326 generated by online retailer 320 may include a unique identifier to identify order A, payment information provided by customer 310, payment approval information received from financial institution 330, payment authorization information provided to shipping company 340, etc. Also as in FIGS. 1-2, each organization providing a service may verify its performance of one or more tasks associated with the requested service. In FIG. 3, such verifications are provided to whichever organization made the specific request for a service rather than to the original requesting service (as in FIG. 1) or a third-party organization (as in FIG. 2). For example, customer 310 may verify 318 to shipping company 340 that shipment has been completed (by, for example, signing for the package); shipping company 340 may then verify 348 to online retailer 320 that shipment has been completed; online retailer 320 may then verify 328 to financial institution 330 that shipment has been completed; and financial institution 330 may then verify 338 to customer 310 that shipment has been completed (by, for example, charging customer's account). That is, each organization in transaction 300 would verify to each preceding organization in the workflow (steps A through G) that the requested services have been provided (i.e., the service-providing organization has performed one or more tasks associated with the requested service). As noted above, such verifications may include, for example, a unique identifier associated with the transaction, a date and/or time a particular task was initiated and/or completed, or other information associated with the transaction as provided by another organization (e.g., a verification provided by another organization). Thus, a complete verification of the entire transaction may be constructed using verifications 318, 348, 328, and 338.

In addition, as in FIGS. 1-2, each organization providing a service (i.e., 320, 330, 340) may create an audit log (e.g., 326, 336, 346) containing information related to the organization's performance of one or more tasks. Information contained in audit logs 326, 336, 346 may include, for example, any information included in verifications 318, 328, 338, 348, a signature or other confirmation obtained in the performance of a task, etc.

Still referring to FIG. 3, transaction 300 may further include another group of verifications 314, 335, 325 used to confirm charges/payments made in providing the various services of transaction 300. For example, verification 314 from consumer 310 to financial institution 330 may confirm a charge made to consumer's account; verification 335 from financial institution to online retailer 320 may confirm a charge from online retailer 320 to financial institution 330 (i.e., step B); and verification 325 from online retailer 320 to shipping service 340 may confirm a charge from shipping service 340 to online retailer 320 (i.e., step E).

The verifications described above greatly reduce the likelihood that transaction 300 may be carried out fraudulently. That is, transaction 300 could not be completed simply through the use of a stolen or fraudulently obtained credit card. Completion of transaction 300 would also require the fraudulent completion of verifications 314 and 318.

In addition, the verifications described above also make much more difficult the fraudulent or unsatisfactory provision of services among the organizations themselves. That is, the improper provision of services or charges based on services not provided would require at least two organizations to conspire to commit such fraud (e.g., shipping service 340 and financial institution 330 would each have to conspire to create and use a fraudulent verification from consumer 310).

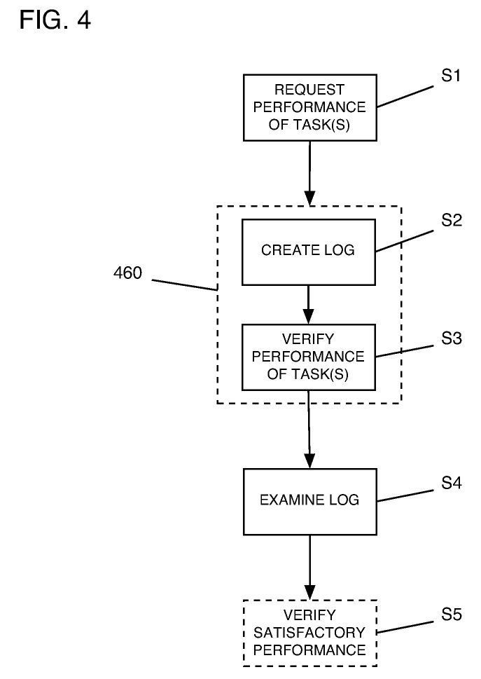

Referring now to FIG. 4, a flow diagram of an illustrative method according to the invention is shown. At step S1, a first organization or entity requests that a second organization or entity provide a service (i.e., perform one or more tasks). At step S2, the second organization/entity creates a log of data associated with its performance of the requested task(s) and at step S3 verifies to the first organization/entity that the requested task(s) were performed. Steps S2 and S3 may optionally be performed by a third-party organization/entity 460 rather than the second organization/entity. Next, at step S4, the first organization/entity examines the log created at step S1 and, at step S5, optionally verifies that the performance of the requested task(s) was satisfactory.

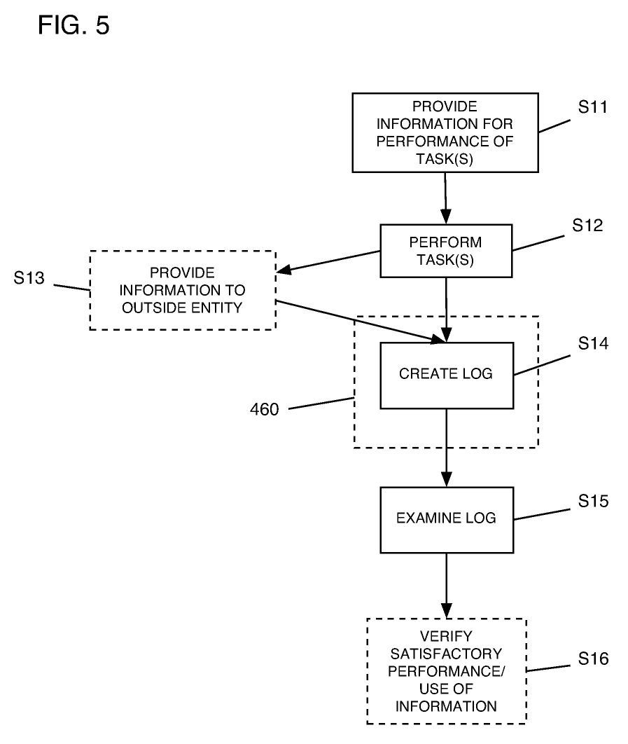

FIG. 5 shows a flow diagram of an alternative method according to the invention. The method of FIG. 5 may be employed, for example, in the case that a first entity wishes to determine how data it provides is used by a second entity. Such a method may be important in ensuring the security of sensitive information, including financial information (e.g., credit card account information, bank account information, etc.) or personally-identifiable information (e.g., social security number, home address, home phone number, email address, etc.).

First, at step S11, a first entity provides information to a second entity. Such a provision of information may be made, for example, in connection with the first entity's request that the second entity perform a particular task. Next, at step S12, the second entity performs one or more tasks. Such tasks may include tasks requested by the first entity or other tasks.

At optional step S13, the second entity may provide to an outside entity the information it was provided in step S11. Such a provision of information may be legitimate (i.e., made in connection with the second entity's performance of one or more tasks in step S12, as authorized by the first entity) or illegitimate (i.e., made outside the authority granted by the first entity or contrary to the authority granted by the first entity). For example, a legitimate provision of information to an outside entity at step S13 may include the second entity's provision of credit card or bank account information to the credit card company or bank in order to collect payment for the performance of the tasks of step S12, as shown in FIG. 3. An illegitimate provision of information at step S13, on the other hand, may include, for example, the disclosure of personally-identifiable information, such as the first entity's address, phone number, or email address, to a marketing company or other entity engaged in solicitation via mail, telephone, or email; the unauthorized use of the first entity's credit card or bank account information, including the collection of an amount other than that authorized by the first entity; or the archiving of information provided at step S11 in a database or other storage medium. While optional step S13 has been described as including the disclosure of information to an outside entity, it should be recognized that an “outside” entity, as used herein, may include a division, subunit, etc. of the second entity other than the division, subunit, etc. to which the information was provided in step S11.

At step S14, an audit log is created, as described above. Here, the audit log includes information regarding how the information provided in step S11 was used. Such information may include, for example, provisions of information such as that of optional step S13. As described above, step S14 may optionally be performed by a third entity 460.

At step S15, the log created at step S14 is examined, typically by the first entity. Here, where the method may be used to ensure the security of information provided at step S11, step S15 includes determining how such information was used by the second entity, including any disclosures made at optional step S13. As such, the first entity is able to determine at optional step S16 whether the second entity's use of the information provided at step S11 complied with the authority it granted the second entity.

It should be understood that the methods of FIGS. 4 and 5 are merely illustrative examples of methods according to the invention. Other methods involving cross-organizational audits are possible, of course, and within the scope of the invention.

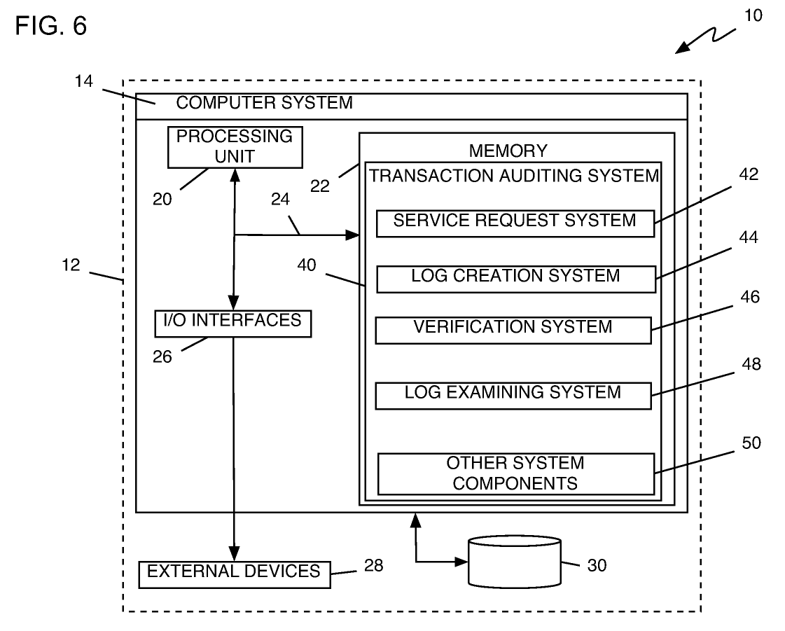

FIG. 6 shows an illustrative system 10 for conducting a cross-organizational transaction audit. To this extent, system 10 includes a computer infrastructure 12 that can perform the various process steps described herein for conducting a cross-organizational transaction audit. In particular, computer infrastructure 12 is shown including a computer system 14 that comprises a transaction auditing system 40, which enables computer system 14 to conduct a cross-organizational transaction audit by performing the process steps of the invention.

Computer system 14 is shown including a processing unit 20, a memory 22, an input/output (I/O) interface 26, and a bus 24. Further, computer system 14 is shown in communication with external devices 28 and a storage system 30. As is known in the art, in general, processing unit 20 executes computer program code, such as transaction auditing system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and transaction auditing system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, transaction auditing system 40 enables computer system 14 to conduct a cross-organizational transaction audit. To this extent, transaction auditing system 40 is shown including a service request system 42, a log creation system 44, a verification system 46, and a log examining system 48. Operation of each of these systems is discussed above. Transaction auditing system 40 may further include other system components 50 to provide additional or improved functionality to transaction auditing system 40. It is understood that some of the various systems shown in FIG. 6 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for conducting a cross-organizational transaction audit, it is understood that the invention further provides various alternative embodiments. For example, in one embodiment, the invention provides a computer-readable medium that includes computer program code to enable a computer infrastructure to conduct a cross-organizational transaction audit. To this extent, the computer-readable medium includes program code, such as transaction auditing system 40, which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to conduct a cross-organizational transaction audit as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for conducting a cross-organizational transaction audit. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for auditing a transaction between a plurality of entities, the method comprising:
a first entity requesting that a second entity perform a task;
creating a log of information related to the second entity's performance of the task;
verifying to the first entity that the task was performed; and
examining the log to determine at least one of the following: whether the second entity's performance of the task was satisfactory and how the second entity used information provided by the first entity in performing the task.

2. The method of claim 1, further comprising:
the first entity verifying that the second entity's performance of the task was satisfactory.

3. The method of claim 1, wherein requesting includes communicating to the second entity a unique identifier associated with the task.

4. The method of claim 3, wherein the log includes the unique identifier associated with the task and at least one additional identifier associated with the second entity's performance of the task.

5. The method of claim 1, wherein requesting includes providing the second entity with the information used by the second entity in performing the task.

6. The method of claim 5, wherein the log includes information used by the second entity in performing the task.

7. The method of claim 1, wherein examining the log includes determining whether the second entity disclosed the information to a third entity.

8. The method of claim 1, wherein creating and verifying are performed by a third entity.

9. The method of claim 1, wherein creating, verifying, and examining are performed according to a protocol agreed upon by the first entity and the second entity.

10. A system for auditing a transaction between a plurality of entities, the system comprising:
a system for permitting a first entity to request that a second entity perform a task;
a system for creating a log of information related to the second entity's performance of the task;
a system for verifying to the first entity that the task was performed; and
a system for examining the log to determine at least one of the following: whether the second entity's performance of the task was satisfactory and how the second entity used information provided by the first entity in performing the task.

11. The system of claim 10, further comprising:
a system for verifying that the second entity's performance of the task was satisfactory.

12. The system of claim 10, wherein the log includes at least one of the following: a unique identifier associated with the task and an additional identifier associated with the second entity's performance of the task.

13. The system of claim 10, wherein a third entity creates the log of information related to the second entity's performance of the task and verifies to the first entity that the task was performed.

14. The system of claim 10, wherein the log includes information used by the second entity in performing the task.

15. The system of claim 10, wherein the system for examining includes a system for determining whether the second entity disclosed the information to a third entity.

16. The system of claim 10, wherein creating and verifying are performed by a third entity.

17. A program product stored on a computer-readable medium, which, when executed conducts an audit of a transaction between a plurality of entities, the program product comprising:
program code for permitting a first entity to request that a second entity perform a task;
program code for creating a log of information related to the second entity's performance of the task;
program code for verifying to the first entity that the task was performed; and
program code for examining the log to determine at least one of the following: whether the second entity's performance of the task was satisfactory and how the second entity used information provided by the first entity in performing the task.

18. The program product of claim 17, further comprising:
program code for verifying that the second entity's performance of the task was satisfactory.

19. The program product of claim 17, wherein the program code for examining includes program code for determining whether the second entity disclosed the information to a third entity.

20. A method for deploying an application for auditing a transaction between a plurality of entities, comprising:
providing a computer infrastructure being operable to:
permit a first entity to request that a second entity perform a task;
create a log of information related to the second entity's performance of the task;
verify to the first entity that the task was performed; and
examine the log to determine at least one of the following: whether the second entity's performance of the task was satisfactory and how the second entity used information provided by the first entity in performing the task.
